(19) United States
(12) Patent Application Publication
(10) Pub. No.: US 2006/0181057 A1
(43) Pub. Date: Aug. 17, 2006

(54) Wheel jack

(76) Inventors: Matthew D. Kollarits, Whitehouse, OH (US); Robert K. Roth, Rochester Hills, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 11/323,175

(22) Filed: Dec. 30, 2005

Related U.S. Application Data
(60) Provisional application No. 60/640,362, filed on Dec. 30, 2004.

(51) Int. Cl. B60D 1/66

(52) U.S. Cl. 280/475

(57) ABSTRACT

A wheel jack comprises a frame, a pair of dowels rotatable with respect to the frame, threaded connectors, each threaded connector mounted on a corresponding dowel, a pair of lever arms movable between a retracted position and an extended position, and a pair of axles, each axle mounted on a corresponding lever arm, wherein the axles are adapted to support a wheel. Rotation of the dowels urges the corresponding threaded connector to move along the dowel, and each threaded connector is pivotably connected to a corresponding lever arm. In operation, the wheel jack is placed under a tire, the axles are raised to engage the wheel so as to lift the wheel off its corresponding wheel mount, and then the wheel is removed from a motor vehicle.

### RELATED APPLICATION

This application claims priority benefit of U.S. provisional patent application No. 60/640,362 filed on Dec. 30, 2004.

### FIELD OF THE INVENTION

This invention relates to wheel jacks, and more particularly to wheel jacks which can be used to remove and attach wheels from motor vehicles.

### BACKGROUND OF THE INVENTION

Known jacks to remove wheels from a motor vehicle typically raise the vehicle off the ground in an amount sufficient to allow clearance between the wheel and the ground. Once that is accomplished, a hub cap and retaining nuts may be removed, allowing manual removal of the wheel from the vehicle. For example, wheel jacks, such as those disclosed in Passow (U.S. Pat. No. 1,555,152) are limited in their range and do not allow for relatively rapid removal of tires. Also, in some cases the tire may be fairly heavy, and there is some risk that the rim of the wheel may be scuffed or scratched during the removal or reinstallation process. In many instances it is desirable to maintain a pristine state of a motor vehicle, particularly the exterior show surfaces and places where chrome is used. Moreover, in situations where a large number of tires have to be removed on a regular basis, such work can be physically tiring, increasingly the likelihood of both injury to the person removing and installing the wheels and damage to the wheel.

It would be desirable to provide a wheel jack which allows for a rapid and repeatable, less labor intensive removal of wheels from motor vehicles that also reduces the likelihood of scuffing or scratching a rim or other exterior show and decorative surfaces of the wheel.

### SUMMARY OF THE INVENTION

In accordance with a first aspect, a wheel jack comprises a frame, a pair of dowels rotatable with respect to the frame, threaded connectors, each threaded connector mounted on a corresponding dowel, a pair of lever arms movable between a retracted position and an extended position, and a pair of axles, with each axle mounted on a corresponding lever arm, wherein the axles are adapted to support a wheel. Rotation of the dowels urges the corresponding threaded connector to move along the dowel, and each threaded connector is pivotably connected to a corresponding lever arm. In operation, the wheel jack is placed under a tire, the axles are raised to engage the wheel so as to lift the wheel off its corresponding wheel mount, and then the wheel is removed from a motor vehicle.

### BRIEF DESCRIPTION OF THE DRAWINGS

FIG. 1 is a top side view of a wheel jack in accordance with a preferred embodiment.

FIG. 2 is a series of side views of the wheel jack of FIG. 1 showing removal of a wheel from a vehicle.

FIG. 3 is a side view of the wheel jack of FIG. 1 show with lever arms in a retracted position.

FIG. 4 is a side view of the wheel jack of FIG. 1 show with lever arms in an extended position.

FIG. 5 shows a perspective view of a clutch cup and spring used to help resist movement of the wheel.

FIG. 6 is a side view of the wheel jack of FIG. 1 showing casters and a soft down stop.

FIG. 7 is another top view showing a hand crank and rollers positioned on a pair of axles.

FIG. 8 is a perspective view of an alternate preferred embodiment where a worm and spur gear are used, connecting the dowels together.

It should be understood that the appended drawings are not necessarily to scale, presenting a somewhat simplified representation of various preferred features illustrative of the basic principles of the invention. The specific design features of the wheel jack as disclosed here, including, for example, specific dimensions of the rollers will be determined in part by the particular intended application and use environment. Certain features of the illustrated embodiments have been enlarged or distorted relative to others for visualization and clear understanding. In particular, thin features may be thickened, for example, for clarity of illustration. All references to direction and position, unless otherwise indicated, refer to the orientation of the wheel jack illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the wheel jack disclosed herein. The following detailed discussion of various alternative and preferred features and embodiments will illustrate the general principles of the invention with reference to a wheel jack suitable for use with wheels on motor vehicles, especially cars and trucks. Other embodiments suitable for other applications will be apparent to those skilled in the art given the benefit of this disclosure.

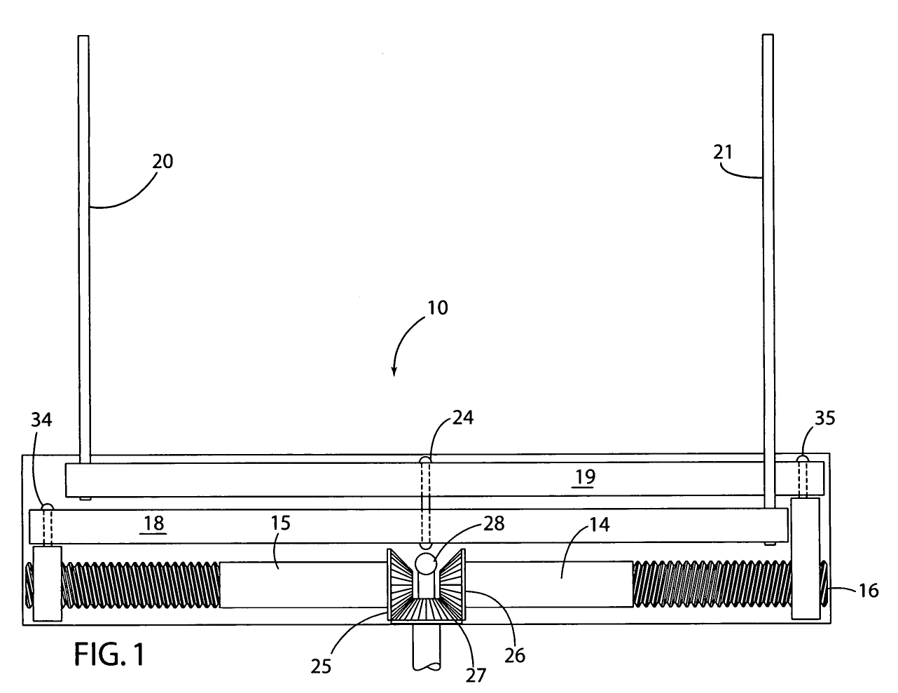

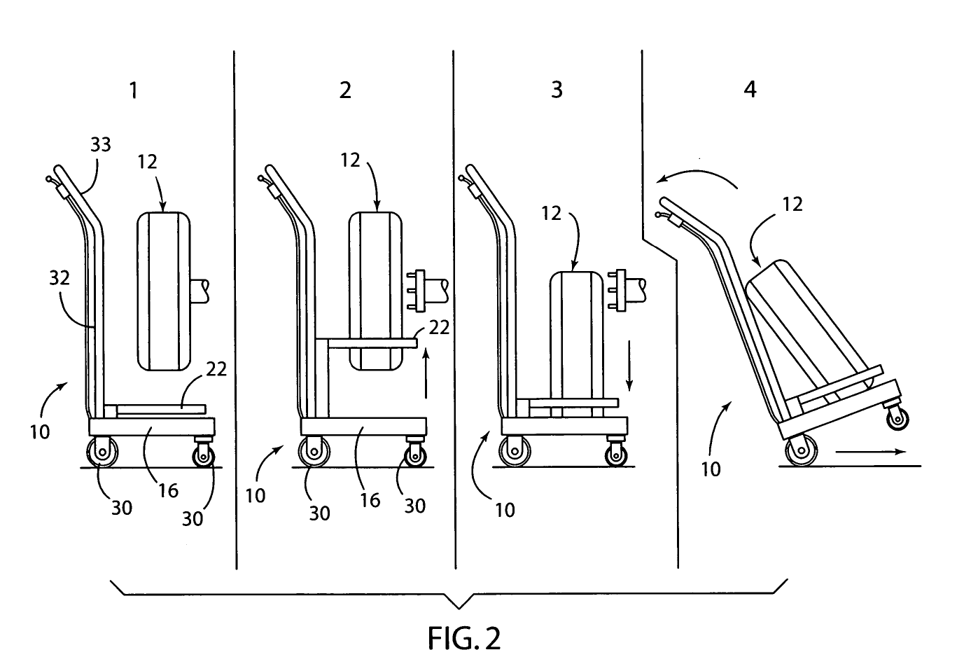

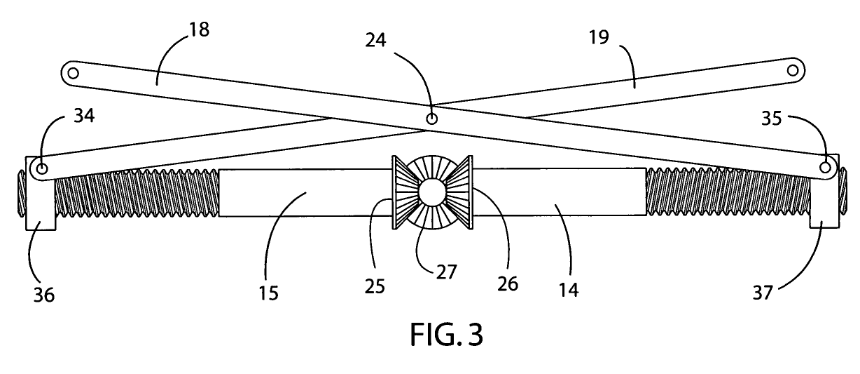

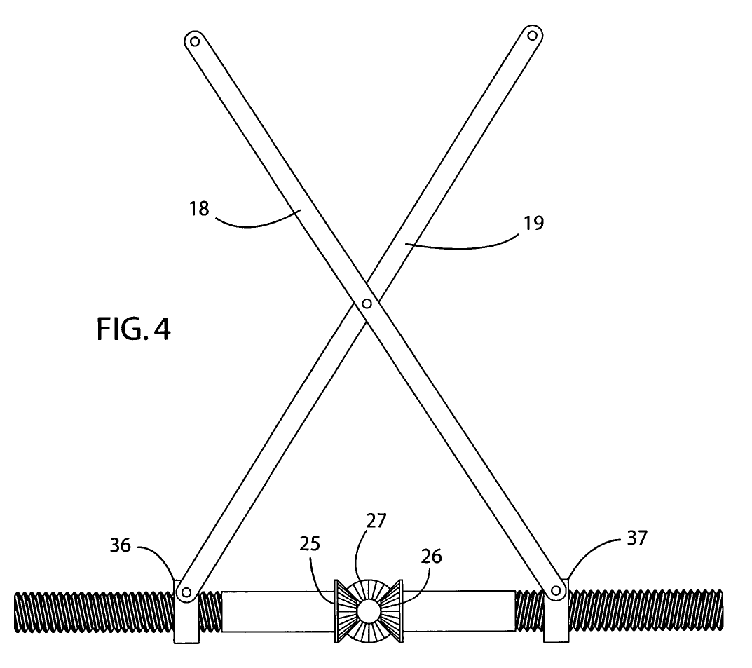

Referring now to the drawings, FIG. 1 shows a wheel jack 10 in accordance with a preferred embodiment. The wheel jack 10 assists in the removal of a wheel 12 (shown in FIG. 2) from a vehicle. A frame 16 supports a pair of dowels 14, 15. The dowels may be rotatably mounted to the frame with, for example, journal bearings. Bevel gears 25, 26 are each mounted on a corresponding dowel, 14, 15, so that the bevel gears rotate with the corresponding dowel. A third gear 27 may be positioned between the bevel gears 25 and 26 so that the gears and dowels all rotate together. The third gear 27 may be operatively connected to another mechanism for control of rotation of the gears and movement of the arms, as discussed in greater detail below. Lever arms 18 and 19 move between a retracted position (shown in FIGS. 1 and 3) and an extended position (FIG. 4) in response to rotation of the dowels. Axles 20, 21 are mounted on corresponding lever arms 19, 18 and move vertically with respect to the ground (and therefore also vertically with respect to the rotatable dowels) as the lever arms move from the retracted position to the extended position.

Preferably the dowels 14, 15 are threaded and receive corresponding threaded connectors 36, 37 (shown in FIG. 3). Rotation of the dowels urges the threaded connectors to translate along the dowels either toward each other or away from each other, as seen in FIGS. 3 and 4. The lever arms 18, 19 are each pivotably connected to the threaded connectors at bottom pivots 34, 35, respectively, and the lever arms are pivotably connected at pivot pin 24. As shown in FIG. 6, optionally an elastomeric stop 38 may be positioned on the frame 16 so that the lever arms 18, 19 (or rollers 22, 23 on the lever arms) contact the stop 38 as they arrive at the retracted position.

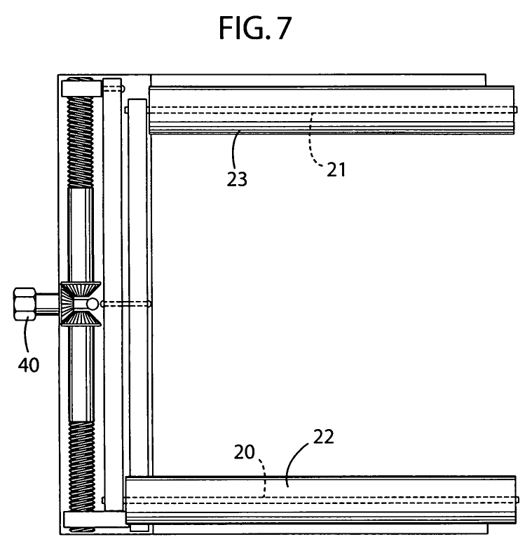

FIG. 7 shows optional guide members 22, 23 preferably formed as rollers mounted around the axles 20, 21. The guide members move vertically and may comprise a cushioning or elastomeric material which directly supports the wheel 12 (FIG. 2.2), advantageously allowing for removal of the wheel from a motor vehicle with reduced likelihood of scuffing, scratching or other damage to the wheel.

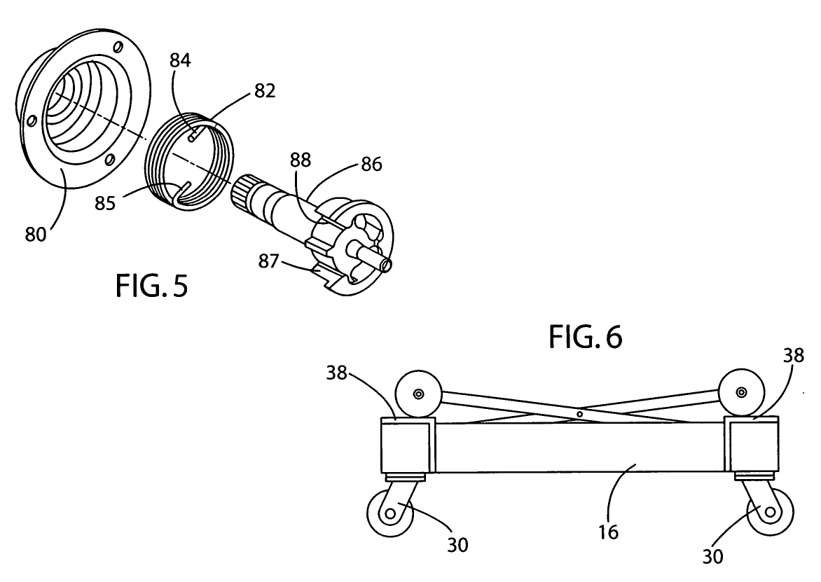

The gears can be rotated either manually as shown (by use of a hand crank connected to spindle 86 which engages the gears) or may be motor driven. A clutch cup assembly 28 may optionally be provided with wheel jacks using a manual hand crank to resist rotation of the dowels when subjected to the load of a wheel. As shown in FIG. 5, a spring 82 is positioned around the spindle 86. A clutch cup 80 is held fixed. At rest, the spring outer diameter engages the clutch cup, restricting rotation of the spindle, which in turn restricts rotation of the bevel gears and dowels, and in turn prevents movement of the lever arms. Upon rotation of the spindle by use of the hand crank 40, the spring disengages the clutch cup to permit rotation of the dowels. More specifically, the spring has spring legs 84 and 85 which will engage surfaces 87, 88 on the spindle, depending on whether the hand crank is rotated clockwise of counterclockwise. Rotation of the spindle in either direction reduces the spring outside diameter, permitting movement of the spindle and rotation of the gears.

FIG. 2 shows a preferred method of removal of a wheel 12 from a motor vehicle. The process may be reversed for installation of a wheel. A first jack (not shown) would be used to lift the motor vehicle so that the wheel 12 is off the ground at least a few inches. FIG. 2.1. Next, the wheel jack 10 is inserted underneath the wheel. Preferably this is accomplished by mounting the frame 16 on rollers or casters 30, so that the guide members 22, 23 may be properly positioned with respect to the wheel or wheels. Once this is accomplished operation of a hand crank 40 (or motor) urges the guide members up into engagement with the wheel, cradling the wheel and cooperating with gravity to prevent vertical movement of the wheel with respect to the rest of the vehicle. (FIG. 2.2) Preferably the guide members hold the wheel so that it is not in contact with any wheel studs. After any hubcap and lug nuts are removed, the wheel may be manually slid off the motor vehicle (FIG. 2.3) and carried away using the handle 33 and vertical frame member 32 to help guide the wheel (FIG. 2.4). Optionally the lug nuts may be loosened prior to inserting the wheel jack, and removed once the guide members are in the operating position.

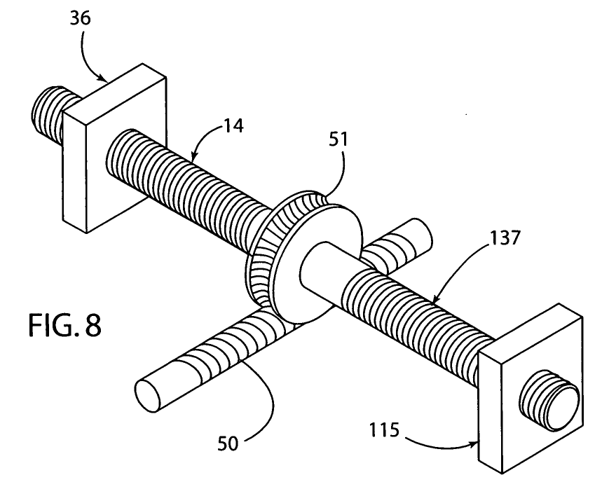

FIG. 8 shows an alternate preferred embodiment where a spur gear 51 connects the dowels 14 and 115. A worm gear 51 drives the spur gear, and may receive an air wrench or other suitable device for assisting with the removal of tires. With both dowels 14, 115 rotating the same way, preferably the threads on one, 137, are reversed (along with the corresponding threads on the threaded connector 137), so that the threaded connectors 36, 137 move in opposite directions to effectively raise and lower the lever arms, axles and any guide members. The worm gear and spur gear may be positioned in a gearbox housing to protect the gear teeth. Other mechanisms suitable for driving the lever arms will be readily apparent to those skilled in the art, given the benefit of this disclosure.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A wheel jack comprising, in combination:
a frame;
a pair of dowels rotatable with respect to the frame;
threaded connectors, each threaded connector mounted on a corresponding dowel;
a pair of lever arms movable between a retracted position and an extended position; and
a pair of axles, each axle mounted on a corresponding lever arm, wherein the axles are adapted to support at least one wheel;
wherein rotation of the dowels urges the corresponding threaded connector to move along the dowel, and each threaded connector is pivotably connected to a corresponding lever arm.

2. The wheel jack of claim 1 wherein the axles move vertically with respect to the dowels.

3. The wheel jack of claim 1 further comprising rollers mounted on the corresponding axle.

4. The wheel jack of claim 1 wherein the lever arms are pivotably connected together.

5. The wheel jack of claim 1 wherein the dowels rotate together.

6. The wheel jack of claim 5 further comprising a bevel gear attached to each dowel, and a third gear operatively connecting each bevel gear so that the dowels rotate together.

7. The wheel jack of claim 1 further comprising a hand crank and a spindle operatively connected to the dowels.

8. The wheel jack of claim 7 further comprising a spring positioned around the spindle and a clutch cup, wherein the spring at rest engages the clutch cup, restricting rotation of the dowels, and upon rotation of the spindle the spring disengages the clutch cup to permit rotation of the dowels.

9. The wheel jack of claim 1 further comprising a spur gear operatively connecting the dowels together, so that rotation of the spur gear forces rotation of the dowels.

10. The wheel jack of claim 9 further comprising a worm gear operatively connected to the spur gear, and adapted to receive an air wrench.

11. The wheel jack of claim 9 wherein each of the dowels has threads, and one of the dowels has threads which are reversed from the other of the dowels, and a corresponding one of the threaded connectors has threads which are reversed from the other threaded connector.
